(19) United States
(12) Patent Application Publication
(10) Pub. No.: US 2011/0143039 A1
(43) Pub. Date: Jun. 16, 2011

(54) PROCESS AND DEVICE FOR COLD SPRAYING

(75) Inventors: Andreas Jakimov, München (DE); Stefan Schneiderbanger, Lauterbach (DE)

(73) Assignee: MTU AERO ENGINES GMBH, München (DE)

(21) Appl. No.: 13/002,313

(22) PCT Filed: Jun. 26, 2009
(86) PCT No.: PCT/DE09/00893

§ 371 Date: Feb. 18, 2011

(30) Foreign Application Priority Data
Jul. 5, 2008 (DE) 10 2008 031 843.4

(51) Int. Cl. B05D 1/02; B05B 1/02; B05C 9/14

(52) U.S. Cl. 427/422; 118/302

(57) ABSTRACT

The invention relates to a process for cold spraying, wherein particles of at least one coating material, together with a carrier gas, are directed onto a surface of a workpiece to be coated by means of a spray gun. According to the invention, the particles of at least one coating material are preheated.

The invention relates to a process for cold spraying according to the preamble of claim 1. In addition, the invention relates to a device for cold spraying according to the preamble of claim 6.

Modern gas turbines, particularly aircraft engines, must meet the highest requirements with respect to reliability, weight, performance, economy and service life. In the last few decades, particularly in the civil sector, aircraft engines have been developed that have fully met the above requirements and have achieved a high degree of technical perfection. Among other things, the selection of material, the search for new, suitable materials, as well as the search for new manufacturing processes play a decisive role in the development of aircraft engines. The most important materials used at the present time for aircraft engines or other gas turbines are titanium alloys, nickel alloys and high-strength steels. High-strength steels are used for shaft parts, gear parts, compressor housings and turbine housings. Titanium alloys are typical materials for compressor parts. Nickel alloys are suitable for the hot parts of the aircraft engine. Investment casting and forging are primarily known in the prior art as manufacturing processes for gas turbine parts made of titanium alloys, nickel alloy or other alloys. All highly stressed gas turbine parts, such as, for example, blades for a compressor, are forged parts. Rotating blades and guide blades of the turbine, in contrast, are usually formed as investment cast parts.

In order to increase the service life of gas turbine parts, it is already known from practice to provide these parts with coatings that protect from wear. Cold spraying, which is also called kinetic cold gas compacting or the K3 process, can be used in this case as the coating process. However, when kinetic cold spraying is to be conducted with the use of brittle metals as the coating material, high layer porosities will develop in the coating that forms. In some cases, ceramic coating materials cannot be used at all with cold spraying. Therefore, there is a need for a process and a device for cold spraying, by means of which coating materials made of brittle metals and ceramics can also be suitably used for the coating of parts.

Reference is made to DE 10 2007 001 477 B3 as the prior art that relates to cold spraying. Thus, it is known from this prior art to use a spray gun for cold spraying, in order to direct particles of coating material, together with a carrier gas, onto a surface of a workpiece to be coated. According to DE 10 2007 001 477 B3, particles of different coating materials are introduced into different regions of a stagnation chamber of the spray gun.

The problem that is the basis of the present invention, which is to propose a novel process for cold spraying as well as a corresponding device, proceeds from this prior art.

This problem is solved by a process for cold spraying according to claim 1. According to the invention, the particles of at least one coating material are preheated.

It is proposed for the first time here with the present invention to subject particles of a coating material to a preheating in the cold spraying process, prior to introducing them into the spray gun. In this way, it is possible to safely and reliably process even brittle metals and ceramics as coating materials in cold spraying.

The device for cold spraying according to the invention is defined in claim 6.

Preferred enhancements of the invention are taken from the subclaims and the following description. Embodiment examples of the invention will be explained in more detail based on the drawing, but are not limited thereto. Here:

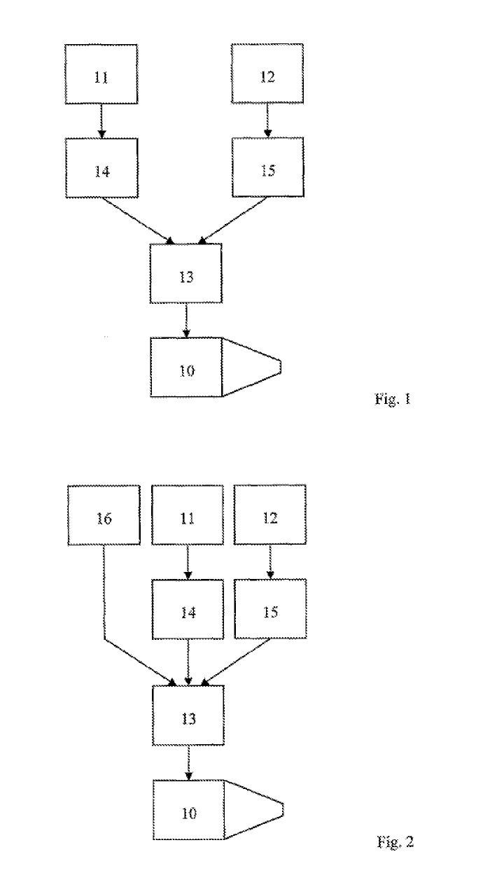

FIG. 1 shows a schematized representation of a device for cold spraying of the invention according to a first example of embodiment of the invention; and

FIG. 2 shows a schematized representation of a device for cold spraying of the invention according to a second example of embodiment of the invention.

The invention presented here relates to the coating of workpieces by means of cold spraying, wherein cold spraying is also called kinetic cold gas compacting or the K3 process.

FIG. 1 shows, in a very schematized manner, a device for cold spraying according to the invention, wherein the device according to the invention of FIG. 1 comprises a spray gun 10, by means of which particles of at least one coating material, together with a carrier gas, can be directed onto a surface of a workpiece to be coated.

The device of FIG. 1 serves for applying particles of two coating materials, wherein first particles of a first coating material are provided to spray gun 10 by means of a first particle conveyor 11, and second particles of a second coating material are provided to spray gun 10 by means of a second particle conveyor 12, and wherein, according to FIG. 1, the first particles of the first particle material are mixed with the second particles of the second particle material in a mixing apparatus 13 before they are introduced into spray gun 10.

In the sense of the present invention, here, particles of at least one coating material are preheated, in fact, prior to their introduction into spray gun 10, whereby, for this purpose, in the example of embodiment of FIG. 1, the device for cold spraying according to the invention comprises two preheating means 14, 15.

A first preheating means 14 serves for preheating the first particles of the first coating material, which are provided by means of the first particle conveyor 11. The second preheating means 15 serves for preheating the second particles of the second particle material, which are provided by means of the second particle conveyor 12.

Preheating is conducted according to FIG. 1 in such a way that the particles are subjected to preheating prior to their introduction into mixing apparatus 13.

The temperatures at which the particles are heated by means of preheating means 14, 15 are temperatures that are specific to the coating material. Thus, the particles of a special coating material are heated to a temperature adapted to this special coating material.

FIG. 2 shows an example of embodiment of the invention, which essentially corresponds to the example of embodiment of FIG. 1, for which reason, in order to avoid unnecessary repetition, the same reference numbers are used for the same components. The example of embodiment of FIG. 2 differs from the example of embodiment of FIG. 1 only by the fact that particles made of three different coating materials are introduced into mixing apparatus 13, whereby, for this purpose, the device of FIG. 2 comprises a third particle conveyor 16. In the example of embodiment of FIG. 2, the third particles of the third coating material, which are provided by means of the third particle conveyor 16, however, are not subjected to a preheating, but rather only the first particles of the first particle material and the second particles of the second particle material, which are provided to spray gun 10 by means of particle conveyors 11, 12, are preheated.

Accordingly, in the sense of the present invention, here, particles of a coating material for cold spraying are to be heated to a material-specific temperature prior to injection into the spray gun. The particles heated to different temperatures are preferably mixed in mixing apparatus 13 before they are injected into spray gun 10. The invention is particularly suitable for coating workpieces with coating materials made of brittle metals or ceramics. In particular, the invention finds use for the coating of workpieces with Ti6Al4V.

1. A process for cold spraying, wherein particles of at least one coating material, together with a carrier gas, are directed onto a surface of a workpiece to be coated by means of a spray gun, is hereby characterized in that
the particles of at least one coating material are preheated.

2. The process according to claim 1,
further characterized in that
the particles of the coating material or of each coating material are preheated prior to their introduction into the spray gun.

3. The process according to claim 1 or 2,
further characterized in that
the particles of the coating material or of each coating material are preheated to a temperature that is specific for the coating material.

4. The process according to one of claims 1 to 3,
further characterized in that
first particles of a first coating material are preheated to a first temperature specific to the coating material and second particles of a second coating material are preheated to a second temperature specific to the coating material.

5. The process according to one of claims 1 to 4,
further characterized in that
the particles heated to the temperatures specific to the coating material are mixed before they reach the region of the spray gun.

6. A device for cold spraying, with a spray gun, by means of which particles of at least one coating material, together with a carrier gas, are directed onto a surface of a workpiece to be coated is hereby characterized by
at least one preheating means (14, 15) in order to preheat particles of at least one coating material.

7. The device according to claim 6,
further characterized in that
the preheating means or each preheating means (14, 15) is placed upstream to spray gun (10) so that the respective preheating means preheats the particles of the respective coating material prior to introducing them into the spray gun.

8. The device according to claim 7,
further characterized in that
the respective preheating means (14, 15) preheats the particles of the respective coating material to a temperature that is specific to the coating material.

9. The device according to one of claims 6 to 8,
further characterized in that
a first preheating means (14) preheats first particles of a first coating material to a first temperature that is specific to the coating material, and a second preheating means (15) preheats second particles of a second coating material to a second temperature that is specific to the coating material, and this is done before they reach the region of spray gun (10).

10. The device according to one of claims 6 to 9,
further characterized in that
a mixing apparatus (13), which mixes the particles heated to the temperatures that are specific to the coating materials, and which in fact does this prior to their reaching the region of spray gun (10), is connected between spray gun (10) and preheating means (14, 15).
